(19) United States
(12) Patent Application Publication
(10) Pub. No.: US 2009/0071229 A1
(43) Pub. Date: Mar. 19, 2009

(54) NOx SENSOR AND METHOD FOR DETECTING NOx

(75) Inventor: Scott GRIMSHAW, Marcellus, NY (US)

Correspondence Address: BURR & BROWN, PO BOX 7068, SYRACUSE, NY, 13261-7068, US

(73) Assignee: Tangidyne Corporation, Marcellus, NY (US)

(21) Appl. No.: 11/873,446

(22) Filed: Oct. 17, 2007

Related U.S. Application Data
(60) Provisional application No. 60/973,586, filed on Sep. 19, 2007.

(51) Int. Cl. G01N 27/00

(52) U.S. Cl. 73/23.31; 73/24.06

(57) ABSTRACT

A NOₓ sensor, comprising a high-temperature piezoelectric element, a NOₓ scavenging element positioned on the piezoelectric element, a first electrode in contact with a first region of the piezoelectric element and a second electrode in contact with a second region of the piezoelectric element. Also, a method of detecting whether NOₓ is present in a space, comprising applying a voltage across a high-temperature piezoelectric element, thereby causing a first portion of the piezoelectric element to undergo vibration, an NOₓ scavenging element being in contact with the first portion of the piezoelectric element; and detecting a resonant frequency of vibration of the first portion of the piezoelectric element.

### CROSS-REFERENCE TO RELATED APPLICATIONS

This application claims the benefit of U.S. Provisional Patent Application No. 60/973,586, filed Sep. 19, 2007, the entirety of which is incorporated herein by reference.

### FIELD OF THE INVENTION

The present invention relates to a sensor which detects the presence and/or concentration of NOₓ, and to a method of detecting the presence and/or concentration of NOₓ.

### BACKGROUND OF THE INVENTION

The formation of nitrogen oxides (NO₂, N₂O and NO, collectively referred to as NOₓ) has been and continues to be a problematic characteristic of the operation of internal combustion engines. The high temperatures in a combustion chamber convert normally unreactive atmospheric nitrogen and oxygen into molecular combinations with varying degrees of toxicity. These molecules are then sent into the atmosphere as engine or furnace exhaust.

Unfortunately, the damage does not stop there. In the presence of sunlight, these gases interact readily with volatile organic compounds (VOC's) such as gasoline fumes, to produce smog, an irritating and potentially deadly form of air pollution.

Mono-nitrogen oxides also react with atmospheric moisture to create nitric acid, a primary component of acid rain. Nitrogen oxides can increase the formation of ozone in the lower atmosphere as well.

In an attempt to mitigate the effects of these pollutants, combustion engineering and emission control research have led to a number of partial remedies, including improved engine or furnace design and the use of exhaust system treatments. One prominent example of the latter category, the catalytic converter, uses the action of various precious metals to convert the nitrogen oxides back to molecular oxygen and nitrogen:

2NOₓ→xO₂+N₂

As emission standards are tightened, and as air pollution caused by NOₓ increases, there is an escalating demand for sensors that can detect the presence of and/or measure the concentration of these NOₓ pollutants. In many cases, these sensors must be placed in or very near the source of the pollution, and this means in a high-temperature environment, typically in excess of 300° C.

There exist a number of types of sensors that have been used to detect NOₓ concentrations in combustion environments. Two types are described below:

One popular high-temperature NOₓ sensor has been based on the development of an electrical potential when a gas molecule passes through a porous ceramic material. Referred to as a “potentiometric” device, in its simplest form, it consists of a metal oxide ceramic such as yttria-stabilized zirconium oxide (YSV), or a complex alumino-silicate mineral called “zeolite”, pressed into the form of a block, or wafer. The sides of the wafer are coated with thin metal electrodes, one of which is relatively porous to the NOₓ molecules. The unequal pressures of NOₓ on the front and back face of the wafer give rise to the movement of the NOₓ molecules through the oxide material. As the NOₓ passes through electrodes, a voltage (or potential) develops. This voltage is proportional to the difference in gas pressures and is calculated using the Nernst equation.

A second type of NOₓ sensor utilizes a thin coating on a quartz crystal microbalance (QCM). This is a highly sensitive device that has been reported to develop a proportionate signal to the concentration of NO. The QCM NOₓ sensor operates on the principle that a vibrating quartz disk responds to mass adsorbed on its surface by raising or lowering its frequency of oscillation. This frequency change can then be correlated to the concentration of the chemical agent being analyzed. Zeolite coatings have been deposited on QCM's used to detect NO (see U.S. Pat. No. 6,843,900, col. 2, lines 21-29).

A significant limitation on the use of QCM NOₓ sensors is the maximum effective operating temperature of quartz. Under ideal conditions, it is approximately 350 degrees C. Under practical conditions, in regards to stability of operation, this drops further to 100-150 degrees C. This is a consequence of the high change of oscillation frequency with temperature, which leads to a noisy and erratic sensor. Even if this instability could be compensated for electronically, at approximately 550 degrees C., quartz undergoes a crystallographic phase change and is no longer useable as a piezoelectric device.

### BRIEF SUMMARY OF THE INVENTION

All NOₓ sensors have limitations in regard to sensitivity (ppm range), selectivity (responding to only NOₓ and no other gases), durability, operating temperature range and response time. It is an ongoing pursuit to improve these characteristics in the hope of producing the “ultimate” sensor. And it is with the interest in that pursuit that a novel NOₓ sensor is proposed, with significantly enhanced properties over currently available devices.

According to a first aspect of the present invention, there is provided a NOₓ sensor, comprising:

a high-temperature piezoelectric element;

an NOₓ scavenging element positioned on the piezoelectric element;

a first electrode, the first electrode being in contact with at least a first region of the piezoelectric element; and

a second electrode, the second electrode being in contact with at least a second region of the piezoelectric element, the second region being spaced from the first region.

In some embodiments according to this aspect of the present invention, the sensor further comprises a resonant frequency detector for detecting a resonant frequency of vibration of the piezoelectric element.

In some embodiments according to this aspect of the present invention, the sensor further comprises a power supply which applies a voltage between the first electrode and the second electrode across the piezoelectric element.

In some embodiments according to this aspect of the present invention, the sensor is positioned within an exhaust conduit, a reaction chamber, a deposition chamber, a furnace or a storage vessel.

According to a second aspect of the present invention, there is provided a method of detecting whether NOₓ is present in a space, comprising:

applying a voltage across a high-temperature piezoelectric element from a first electrode to a second electrode, the first electrode being in contact with a first region of the piezoelectric element, the second electrode being in contact with a second region of the piezoelectric element, thereby causing a first portion of the piezoelectric element to undergo vibration, an NOₓ scavenging element comprising a scavenging compound being in contact with the first portion of the piezoelectric element;

detecting a resonant frequency of vibration of the first portion of the piezoelectric element.

In some embodiments according to this aspect of the present invention, the method further comprises detecting a concentration of NOₓ in the space.

The NOₓ scavenging element comprises an NOₓ scavenging compound, i.e., any compound that chemically bonds to NOₓ. Representative examples of NOₓ scavenging compounds include an oxide, a hydroxide or a carbonate of an alkali metal or an alkali earth metal, e.g., BaO, LiO, NaO, KO, RbO, CsO, FrO, BeO, MgO, CaO, SrO, RaO, BaOH, LiOH, NaOH, KOH, RbOH, CsOH, FrOH, BeOH, MgOH, CaOH, SrOH, RaOH, BaCO₃, LiCO₃, NaCO₃, KCO₃, RbCO₃, CsCO₃, FrCO₃, BeCO₃, MgCO₃, CaCO₃, SrCO₃, and RaCO₃

For example, where the NOₓ scavenging compound is BaO, the following chemical reaction occurs when the BaO is contacted by NOₓ:

BaO+yNOₓ→Ba(NO₃)₂+(optionally) other by-products,

with Ba(NO₃)₂ being the scavenging reaction product.

In some embodiments according to the present invention, the NOₓ scavenging element comprises at least a first layer of a scavenging compound, e.g., a layer of BaO.

In some embodiments according to the present invention, the NOₓ scavenging element comprises at least a first particle of a scavenging compound, e.g., a particle of BaO.

In some embodiments according to the present invention, the high-temperature piezoelectric element comprises at least one material selected from among the group consisting of gallium phosphate, langasite, langatite, langanite and high-temperature piezoceramics.

In some embodiments according to the second aspect of the present invention, the method further comprises causing at least the NOₓ scavenging element to increase in temperature to a temperature which is high enough that a portion of any scavenging reaction product on the NOₓ scavenging element is chemically reacted to yield the scavenging compound.

For example, where the NOₓ scavenging compound is BaO, the following chemical reaction occurs to chemically react the scavenging reaction product (Ba(NO₃)₂) to yield (i.e., restore) the scavenging compound (BaO):

2Ba(NO₃)₂→2BaO+4NO₂↑+O₂↑

The invention may be more fully understood with reference to the accompanying drawings and the following detailed description of the invention.

### BRIEF DESCRIPTION OF THE DRAWING FIGURES

FIG. 1 depicts a first embodiment of an NOₓ sensor according to the present invention.

FIG. 2 depicts a second embodiment of an NOₓ sensor according to the present invention.

FIG. 3 depicts a third embodiment of an NOₓ sensor according to the present invention.

FIG. 4 depicts a fourth embodiment of an NOₓ sensor according to the present invention.

### DETAILED DESCRIPTION OF THE INVENTION

The expression “on”, e.g., as used herein, means that the first structure which is “on” a second structure can be in contact with the second structure, or can be separated from the second structure by one or more intervening structures (each side, of opposite sides, of which is in contact with the first structure, the second structure or one of the intervening structures).

The expression “in contact”, as used in the present specification, means that the first structure which is “in contact” with a second structure can be in direct contact with the second structure, or can be separated from the second structure by one or more intervening structures (i.e., in indirect contact), where the first and second structures, and the one or more intervening structures each have at least one surface which is in direct contact with another surface selected from among surfaces of the first and second structures and surfaces of the one or more intervening structures.

The expression “in direct contact”, as used in the present specification, means that the first structure which is “in direct contact” with a second structure is touching the second structure and there are no intervening structures between the first and second structures at least at some location.

As noted above, in a first aspect of the present invention, there is provided a NOₓ sensor which comprises a high-temperature piezoelectric element (also referred to herein as a “crystal”), an NOₓ scavenging element, and at least first and second electrodes.

A “high-temperature piezoelectric element”, as that expression is used herein, is a piezoelectric element which has a maximum temperature of oscillation which exceeds 550 degrees C. (and in some cases, 580 degrees C.). Persons of skill in the art are familiar with techniques for determining the maximum temperature of oscillation for a particular piezoelectric element. Representative examples of such high-temperature piezoelectric elements include gallium phosphate (i.e., single crystal gallium orthophosphate, GaPO₄), langasite (La₃Ga₅SiO₁₄), langatite (La₃Ga_{5.5}Ta_{0.5}Oi₁₄) and langatite (La₃Ga_{5.5}Ta_{0.5}O₁₄). The maximum temperature of oscillation for single crystal gallium orthophosphate is about 900 degrees C., and the maximum temperature of oscillation for langasite is about 1,470 degrees C. The maximum temperature of oscillation for quartz is less than 550 degrees C., i.e., quartz is not a high-temperature piezoelectric crystal. Persons of skill in the art are familiar with such piezoelectric elements and have access to such piezoelectric elements. The piezoelectric element can be in any suitable desired shape.

Instead of the class of high-temperature piezoelectric crystals as described above, the class of “temperature-induced phase change-resistant piezoelectric crystals” can be employed. A “temperature-induced phase change-resistant piezoelectric element”, as that expression is used herein, is a piezoelectric element which does not undergo a phase change at a temperature of less than 550 degrees C. Persons of skill in the art are familiar with techniques for determining whether a given material undergoes a phase change at a temperature of less than 550 degrees C. Representative examples of temperature-induced phase change-resistant piezoelectric elements include gallium phosphate (i.e., single crystal gallium orthophosphate, GaPO₄), langasite (La₃Ga₅SiO₁₄), langatite (La₃Ga_{5.5}Ta_{0.5}Oi ₁₄) and langatite (La₃Ga_{5.5}Ta_{0.5}O₁₄). Quartz undergoes a phase change at 550 degrees C., i.e., quartz is not a temperature-induced phase change-resistant piezoelectric element.

The high-temperature piezoelectric crystal can be fashioned to resonate in a variety of modes, including, but not limited to, bulk acoustic wave, surface acoustic wave, flexural plate mode or acoustic plate mode. Persons of skill in the art are familiar with fashioning high-temperature piezoelectric crystals to resonate in such modes. The resulting device can be described as a HTCM, high-temperature crystal microbalance.

As noted above, an NOₓ scavenging element which is suitable for use in the present invention is an element comprising at least one particle of an oxide, a hydroxide or a carbonate of an alkali metal or an alkali earth metal, e.g., a particle of barium oxide (BaO). In some embodiments of the present invention, the NOₓ scavenging element is in the form of a layer of an oxide, a hydroxide or a carbonate of an alkali metal or an alkali earth metal, e.g., a layer of BaO. In some embodiments, the high-temperature piezoelectric element can include layer of an oxide, a hydroxide or a carbonate of an alkali metal or an alkali earth metal, e.g., BaO, on opposite sides.

The first and second electrodes can be any suitable structure which is capable of delivering electricity to the high-temperature piezoelectric element. Persons skilled in the art are familiar with a wide variety of electrodes, and any suitable electrode can be used according to the present invention. Any suitable shape(s) of electrode(s) can be used, and any suitable material(s) can be used to make the electrodes.

As noted above, some embodiments include a resonant frequency detector for detecting a resonant frequency of vibration of the piezoelectric element. Such devices are well-known to those of skill in the art, and any suitable resonant frequency detector can be employed in such embodiments.

As noted above, some embodiments include a power supply which applies a voltage between the first electrode and the second electrode across the piezoelectric element. Such power supply devices are well-known to those of skill in the art, and any suitable power supply can be employed in such embodiments.

As noted above, in some embodiments according to this aspect of the present invention, the sensor is positioned within an exhaust conduit (e.g., an exhaust pipe on vehicle, such as an automobile, a truck, a motorcycle, etc., an exhaust for a furnace, a chimney, etc.), a reaction chamber (i.e., any chamber in which chemical reactions are carried out), a deposition chamber (i.e., any chamber in which one or more materials is/are deposited on one or more other materials, such as by chemical vapor deposition [CVD], epitaxial growth, physical vapor deposition [PVD], close-spaced vapor deposition [CSVD], liquid phase epitaxy [LPE], thin-film formation, etc.), a furnace or combustion chamber (i.e., any chamber in which one or more materials are combusted), or a storage vessel (i.e., any chamber in which one or more materials are stored).

In some situations, if desired, the NOₓ sensor can be held by a holder. The holder can be generally any desired shape, and can hold the NOₓ sensor in any desired manner. For instance, one example of a suitable holder is a toroid-shaped device which is open on opposite sides, in which an NOₓ sensor which comprises a thin disc-shaped piezoelectric element which is coated on each side with a scavenging element, whereby the scavenging elements on the opposite sides of the NOₓ sensor are exposed (and the NOₓ can be placed within an environment which may contain NOₓ). Alternatively, for example, the NOₓ sensor can be suspended so that it “dangles” within an environment which may contain NOₓ.

If sulfur is present, it can react with the scavenging compound (e.g., BaO) to produce a sulfate, which poisons the sensor. In some embodiments of the present invention, the scavenging element further comprises catalytic material which, when contacted with sulfur and/or nitrogen, in the presence of fuel (e.g., a rich fuel “burst”) with or without NOₓ, catalyzes chemical reactions which avoid or reduce loss of the scavenging compound through undesired chemical reaction. For example, in the case where the scavenging compound is BaO, catalyst comprising rhodium and ZrO₂, and/or catalyst comprising platinum and ZrO₂, can be employed for this purpose.

As noted above, according to a second aspect of the present invention, there is provided a method of detecting whether NOₓ is present in a space, comprising:

applying a voltage across a high-temperature piezoelectric element from a first electrode to a second electrode, the first electrode being in contact with a first region of the piezoelectric element, the second electrode being in contact with a second region of the piezoelectric element, thereby causing a first portion of the piezoelectric element to undergo vibration, an NOₓ scavenging element being positioned in contact with the first portion of the piezoelectric element;

detecting a resonant frequency of vibration of the first portion of the piezoelectric element.

The discussion above with respect to selections which can be made in providing the high-temperature piezoelectric element, the electrodes and the scavenging element apply with respect to such methods as well.

As noted above, in some embodiments according to the second aspect of the present invention, the method further comprises detecting a concentration of NOₓ in the space. Because changes in the mass of the scavenging reaction product (e.g., Ba(NO₃)₂ where the scavenging element comprises BaO) formed as a result of reaction of the scavenging compound (e.g., BaO) with NOₓ is proportional to the concentration of NOₓ, and because changes in the resonant frequency of vibration of the first portion of the piezoelectric element is proportional to the mass of material on the first portion of the piezoelectric element, persons of skill in the art can readily employ a resonant frequency detector to sense the concentration of NOₓ in the space.

In the event that other materials (e.g., water) which can react and/or attach to the scavenging elements of the present invention are known or suspected to exist in the space, methods can be employed for detecting the concentration of such other materials so as to make an adjustment to the concentration reading for NOₓ. For example, a separate piezoelectric element with a different scavenging element selected for its ability to react with one or more of such other materials can be employed (alternatively, a piezoelectric element can be employed which has a plurality of different regions, on which one or more respective differing NOₓ scavenging elements is/are provided can be employed, and different resonant frequencies of vibration can be detected in the different regions of the piezoelectric element). In some embodiments according to the present invention, in order to counteract the effects of water, which can react with some of the scavenging compounds to form a hydroxide (e.g., water can react with barium oxide to form barium hydroxide), the NOₓ sensor can be maintained at an elevated temperature (“baked”), to inhibit formation of, or to break down the hydroxide (e.g., BaOH breaks down at about 400 degrees C.).

As noted above, if sulfur is present, it can react with the scavenging compound (e.g., BaO) to produce a sulfate, which poisons the sensor. Such sulfates (e.g., BaS) can be driven off by subjecting the scavenging element to elevated temperatures (e.g., for BaS, about 600 degrees C.).

As noted above, in some embodiments according to the second aspect of the present invention, the method further comprises causing at least the NOₓ scavenging element to increase in temperature to a temperature which is high enough that a portion of any scavenging reaction product (e.g., Ba(NO₃)₂ where the scavenging compound is BaO) on the NOₓ scavenging element converts back to the scavenging compound (e.g., BaO) and by-products.

In some embodiments according to the second aspect of the present invention, sulfates can be driven off and scavenging reaction product can be converted to scavenging compound in the same heating step (e.g., where the scavenging compound is BaO, by heating to about 600 degrees C. for a period of time which is sufficient to achieve the desired degree of sulfate removal and/or scavenging compound regeneration.

In some embodiments of the present invention, periodic temperature elevation is provided (e.g., every time a particular period of time passes) in order to drive of sulfates and/or regenerate scavenging compound.

An integral temperature-controlling thin-film structure optionally may be in contact with or near the crystal and/or the scavenging element, if desired. Persons of skill in the art can readily envision a variety of suitable structures which can be employed to enable the temperature of the crystal to be controlled. For example, a thin-film electrode (e.g., a thin layer of gold) can be laminated to the crystal.

Alternatively or additionally, a heater can be employed which is placed near or in contact with the crystal and/or the scavenging element.

There are a number of reasons why it might be advantageous, in certain situations, to heat the crystal and/or the scavenging element to desired operating temperatures. For example, scavenging compound (e.g., BaO) adsorption of NOₓ is a function of temperature. In addition, since the resonant frequency of vibration of a piezoelectric element is affected by temperature, maintaining the temperature of the piezoelectric element within a narrow temperature range generally increases the accuracy of the microbalance. In view of the high temperatures frequently encountered along with the emission of NOₓ, the temperature of the crystal can be more effectively controlled at higher temperatures, e.g., by maintaining the temperature of the crystal at or above the temperature of the exhaust gas. The temperature of the crystal and/or the scavenging element can be controlled, e.g., through the inclusion of a temperature sensor (e.g., a thermistor or a thermocouple) which provides feedback control to the power supply and/or the heater. In many cases, the crystal and the scavenging layer are very thin, such that one or both of them, as desired, can be heated up very rapidly (e.g., from room temperature to 100 degrees C. in a few seconds). If desired, a “trickle” current can be provided to maintain the crystal and/or the scavenging element at an elevated temperature (e.g., in an automobile, the crystal can be maintained at 100 degrees C. in order to provide accurate NOₓ readings even from the time ignition is initiated).

Suitable adhesion layers may be desired to compensate for the chemical characteristics of the piezoelectric crystal. For instance, if the crystal comprises platinum and the scavenging element comprises BaO, BaO does not adhere well to platinum, and so one or more intervening layers (e.g., titanium) can be employed (titanium and platinum form an alloy, and titanium forms an oxide which bonds to BaO; likewise, chromium can be used to improve adhesion of gold to quartz. Persons of skill in the art are familiar with a variety of combinations of materials which do not adhere well to each other, and with a variety of adhesion layers which can be employed, depending on the nature of the respective layers to be adhered, to improve adhesion.

The electrodes and the scavenging element, along with any other structures (e.g., one or more heaters, one or more adhesion layers, etc.) can be attached to the piezoelectric element in any desired order and in any desired arrangement, so long as the necessary electrical characteristics are maintained (i.e., the piezoelectric element can be vibrated) and at least a portion of the scavenging compound is exposed such that it can be contacted by NOₓ.

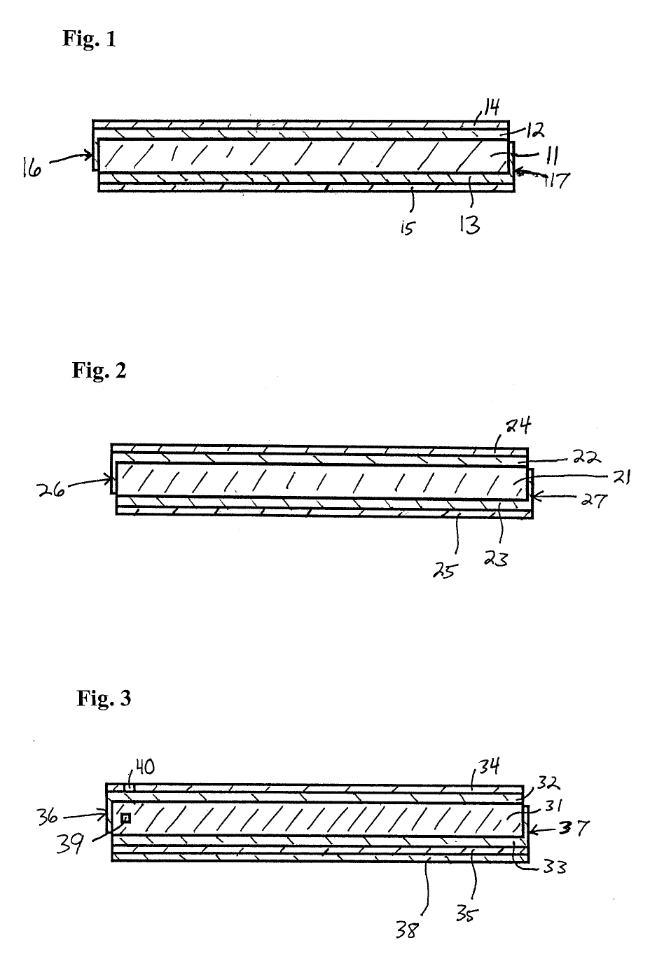

For example, in a first representative embodiment (FIG. 1), a first electrode 12 and a second electrode 13 are provided on opposite sides of a thin disc-shaped piezoelectric element 11 (to provide a bulk acoustic chip), a first scavenging element 14 (in the form of a first layer of BaO) is provided on one side of the piezoelectric element 11 (covering the first electrode), a second layer scavenging element 15 (in the form of a second layer of BaO) is provided on the other side of the piezoelectric element 11 (covering the second electrode), and respective contact regions 16 and 17 of the electrodes are exposed on respective edge regions of the piezoelectric element 11 such that electricity can be supplied to the piezoelectric element 11 via the contact regions.

In a second representative embodiment (FIG. 2), a first electrode 22 and a second electrode 23 are provided on opposite sides of a thin disc-shaped piezoelectric element 21, a first scavenging element 24 (in the form of a layer of BaO) is provided on one side of the piezoelectric element 21 (covering the first electrode), a thin-film resistance heater 25 is provided on the other side of the piezoelectric element 21 (covering the second electrode), and respective contact regions 26 and 27 of the electrodes are exposed on respective edge regions of the piezoelectric element 21 such that electricity can be supplied to the piezoelectric element 21 via the contact regions.

In a third representative embodiment (FIG. 3), a first electrode 32 and a second electrode 33 are provided on opposite sides of a thin disc-shaped piezoelectric element 31, a first scavenging element 34 (in the form of a first layer of BaO is provided on one side of the piezoelectric element 31 (covering the first electrode), a thin-film resistance heater 35 is provided on the other side of the piezoelectric element 31 (covering the second electrode), a second scavenging element 38 (in the form of a second layer of BaO) is provided on and covering the thin-film resistance heater 35, and respective contact regions 36 and 37 of the electrodes are exposed on respective edge regions of the piezoelectric element 31 such that electricity can be supplied to the piezoelectric element via the contact regions. FIG. 3 also depicts a temperature sensor 39 which senses the temperature of the piezoelectric element 31, and a temperature sensor 40 which senses the temperature of the first scavenging element 34.

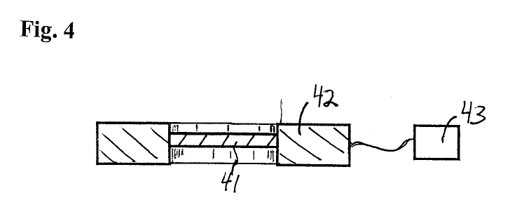

A fourth representative embodiment (FIG. 4) depicts a NOₓ sensor 41 (according to any of the first, second and third embodiments described above), mounted in a holder 42, and electrically connected to a resonant frequency detector 43.

The following is a description of a further representative embodiment of a NOₓ sensor according to the present invention, and a representative embodiment of a method of detecting whether NOₓ is present in a space, according to the present invention.
1. A high-temperature piezoelectric substrate is suitably fashioned into a crystal microbalance with appropriate frequency vs. temperature characteristics, mode spectrum, contour and surface finish. Metallic electrodes are applied to allow electrical contact to the device. An integral temperature-controlling thin film structure may be applied to the crystal if desired.
2. A thin film (˜1000 Angstroms) of barium oxide is applied to one or both surfaces of the high-temperature piezoelectric crystal. Suitable adhesion layers may be required to compensate for the chemical characteristics of the piezoelectric crystal. The techniques of choice for the film applications include physical vapor deposition and chemical vapor deposition.
3. The microbalance is placed in an environment which contains (or which might contain) NOₓ. The microbalance may be heated to the desired operating temperature, or may be allowed to equilibrate to ambient temperature.
4. The high-temperature piezoelectric crystal is set into oscillation using the appropriate electronic circuitry. A frequency measurement system monitors the change in resonant frequency in operation.
5. The NOₓ comes into contact with the BaO layer. At that point, a chemical reaction occurs:

BaO+y NOₓ→Ba(NO₃)₂+(optionally) other by-products
6. The chemical reaction leads to a mass change. This, in turn, causes the resonance frequency of the HTCM to change. This change is correlated to the concentration of the NOₓ in the measurement environment.
7. At some point, the BaO layer may completely turn to Ba(NO₃)₂. This would lead to a cessation of further measurement
8. The HTCM is then heated to a temperature of decomposition of Ba(NO₃)₂, in the vicinity of 550° C. This causes the following reaction to occur:

2Ba(NO₃)₂→2BaO/+4NO₂↑+O₂↑
9. The sensor is regenerated and can be used to measure NOₓ again.

Any two or more structural parts of the sensors described herein can be integrated. Any structural part of the sensors described herein can be provided in two or more parts which are held together, if necessary. Similarly, any two or more functions can be conducted simultaneously, and/or any function can be conducted in a series of steps.

1. A NOₓ sensor, comprising:
a high-temperature piezoelectric element;
an NOₓ scavenging element positioned on said piezoelectric element;
a first electrode, said first electrode being in contact with at least a first region of said piezoelectric element; and
a second electrode, said second electrode being in contact with at least a second region of said piezoelectric element, said second region being spaced from said first region.

2. A sensor as recited in claim 1, wherein said sensor further comprises a resonant frequency detector for detecting a resonant frequency of vibration of said piezoelectric element.

3. A sensor as recited in claim 1, wherein said NOₓ scavenging element comprises at least a first layer comprising at least one scavenging compound

4. A sensor as recited in claim 3, wherein said scavenging compound comprises barium oxide.

5. A sensor as recited in claim 1, wherein said NOₓ scavenging element comprises at least a first particle comprising at least one scavenging compound.

6. A sensor as recited in claim 5, wherein said scavenging compound comprises barium oxide.

7. A sensor as recited in claim 1, wherein said high-temperature piezoelectric element comprises at least one material selected from among the group consisting of gallium phosphate, langasite, langatite and langanite.

8. A sensor as recited in claim 1, wherein said sensor further comprises a power supply which applies a voltage between said first electrode and said second electrode across said piezoelectric element.

9. A sensor as recited in claim 1, wherein said sensor is positioned within an exhaust conduit, a reaction chamber, a deposition chamber, a furnace or a storage vessel.

10. A sensor as recited in claim 1, wherein said sensor further comprises a heater.

11. A sensor as recited in claim 1, wherein said NOₓ scavenging element further comprises at least one catalyst.

12. A sensor as recited in claim 11, wherein said catalyst comprises ZrO₂, as well as rhodium and/or platinum.

13. A method of detecting whether NOₓ is present in a space, comprising:
applying a voltage across a high-temperature piezoelectric element from a first electrode to a second electrode, said first electrode being in contact with a first region of said piezoelectric element, said second electrode being in contact with a second region of said piezoelectric element, thereby causing a first portion of said piezoelectric element to undergo vibration, an NOₓ scavenging element being in contact with said first portion of said piezoelectric element;
detecting a resonant frequency of vibration of said first portion of said piezoelectric element.

14. A method as recited in claim 13, wherein said method further comprises detecting a concentration of NOₓ in said space.

15. A method as recited in claim 13, wherein said method further comprises causing at least said NOₓ scavenging element to increase in temperature to a temperature which is high enough that a portion of any scavenging reaction product on the NOₓ scavenging element converts to scavenging compound.

16. A method as recited in claim 15, wherein said scavenging compound is BaO and said scavenging reaction product is Ba(NO₃)₂.

17. A method as recited in claim 13, wherein said NOₓ scavenging element comprises at least a first layer of barium oxide.

18. A method as recited in claim 13, wherein said NOₓ scavenging element comprises at least a first particle of barium oxide.

19. A method as recited in claim 13, wherein said high-temperature piezoelectric element comprises at least one material selected from among the group consisting of gallium phosphate, langasite, langatite and langanite.

20. A method as recited in claim 13, wherein said NOₓ scavenging element further comprises at least one catalyst, and said method further comprises supplying a burst of fuel-rich blend into said space.
